(19) United States
(12) Patent Application Publication
(10) Pub. No.: US 2005/0280388 A1
(43) Pub. Date: Dec. 22, 2005

(54) Circuit for energy conservation

(75) Inventor: Walter R. Evanyk, Plano, TX (US)

Correspondence Address: JONES DAY, 77 WEST WACKER, CHICAGO, IL, 60601-1692, US

(73) Assignee: PowerPulse Technologies, L.P., Richardson, TX (US)

(21) Appl. No.: 11/094,729

(22) Filed: Mar. 30, 2005

Related U.S. Application Data
(60) Provisional application No. 60/573,716, filed on May 20, 2004.

(51) Int. Cl. F02N 3/00

(52) U.S. Cl. 318/471

(57) ABSTRACT

An improved circuit for automatically controlling energy to electrical energy consuming devices according to the well-known equation
Pₒ=Pᵢₙ−Pₗ+Pᵣ (1)
where Pₒ=Power output, Pᵢₙ=Power input, Pₗ=Power losses, and Pᵣ=Residual Power.

Thus, the invention relates to a method and apparatus for obtaining a desired output power, Pₒ, from an electrical load by supplying sufficient pulse time modulation energy, Pᵢₙ, to the device to replace only losses, Pₗ, and to maintain only the residual power, Pᵣ, thus maintaining the desired Power output, Pₒ, and thereby conserving input energy, Piₙ, that would otherwise be wasted.

This application claims the benefit of Provisional Application Ser. No. 60/573,716, filed May 20, 2004.

### BACKGROUND OF THE INVENTION

1. Field of the Invention

The present invention relates in general to improved circuits for controlling energy supplied to electrical energy consuming devices according to the well known power equation
Pₒ=Pᵢₙ−Pₗ (1)
where Pₒ=Power output, Pᵢₙ=Power input, and Pₗ=losses in the device. It is known that when a device reaches its operating condition (i.e. temperature, rotational speed, momentum, and the like), residual power, Pᵣ, becomes a factor in equation (1) above and equation (1) becomes
   Pₒ=Pᵢₙ−Pₗ+Pᵣ (2)
where Pᵣ=Residual Power and where “Residual Power” or “Residual Energy” is defined herein as “residual heat”, “rotational energy”, “linear motion”, “dynamic energy”, “kinetic energy”, or any other term representing potential energy in a device caused by applied power. The residual power can be used to conserve energy used by such a device.

It can be seen in equation (2) that if Pᵢₙ is reduced to equal Pₗ, then the residual power, Pᵣ, is sufficient to maintain the desired output power, Pₒ.

If the residual power, Pᵣ, is small, such as with a small electrical motor, the residual power is small because of low inertia and mass and, therefore, only a small amount of energy can be conserved.

In particular, the invention relates to a method and apparatus for obtaining a desired output power, Pₒ, from an electrical load by simply supplying sufficient pulse time modulated energy, Pᵢₙ, to the device to replace only load losses, Pₗ, and to maintain only the residual power, Pᵣ, thus maintaining the desired Power output, Pₒ, and thereby conserving input energy, Pᵢₙ, that would otherwise be wasted.

2. Related Art

Consider a heating element as an electrical load that is heated to a desired temperature. If the input power is removed, the heating element has stored heat, or residual power, Pᵣ, and continues to generate heat until the heat is dissipated from the element by cooling (energy or power losses, Pₗ). One circuit for automatically providing input power, Pᵢₙ, in an amount equal to the power losses, Pₗ, is disclosed in commonly assigned co-pending provisional patent application Ser. No. 60/545,783. It is known to manually adjust input power to maintain a desired load. A circuit that is manually controlled to set a desired temperature is disclosed in U.S. Pat. No. 6,449,870 and in U.S. Pat. No. 6,718,651.

Also, there are soldering devices that have a control circuit that shuts the power to the tip OFF when a certain temperature is reached and then turns the power ON again when the temperature falls below a desired amount. While it is done automatically, the power is not continuously regulated by a circuit that automatically reduces, or increases, the rate of pulsed (Pulse Time Modulation) power applied to the load to continuously maintain a desired operating condition such as temperature.

For a rotating device, such as a wheel, motor, and the like, when input power to the rotating device is removed, the motor or wheel continues to rotate by means of stored or kinetic energy until frictional energy (power losses) completely expends the kinetic or dynamic energy (residual power).

It would be very desirable to have an improved circuit that provides continuous electrical input power to a an electrical energy consuming device until the device reached its selected desired operating condition and then automatically reduces the input power with the use of Pulse Time Modulation controlled by a feedback circuit to an amount sufficient only to replace power losses to maintain only the residual power thus maintaining the desired power output with a minimum of power input.

### SUMMARY OF THE INVENTION

With the present invention, an electrical energy consuming device is brought to its desired operation condition by applying full input power, Pᵢₙ. When the desired operating condition is reached, the input power, Pᵢₙ, is automatically reduced with Pulse Time Modulation to the amount of power losses, Pₗ, occurring in the device and thus enables the residual power or energy, Pᵣ, that is stored in the device to equal the desired output power, Pₒ.

This is accomplished by providing a feedback circuit representing the desired operating condition of the electrical energy device (i.e. temperature, rotational speed, light brightness, and the like) and generating a signal representative of the instantaneous value of the desired operating condition. That generated feedback signal is coupled as one input to a comparator. The other input is a variable time based electrical reference signal such as, for example only, a sawtooth reference waveform. When the feedback signal is less in amplitude than any portion of the sawtooth reference waveform, the output of the comparator is a pulse time modulated signal (PTM) that is coupled to, and actuates, an electronic switch such as a power FET. The electrical load is coupled between the power input source and the electronic switch. The pulse time modulated signal is coupled to the gate of the electronic switch to automatically switch it ON and OFF at a rate sufficient to supply just enough power to the load to replace power losses (i.e. cooling) and thus maintain the desired operating condition as determined by the feedback signal.

Also, for the improved circuit disclosed herein, where the input feedback signal is generated by a temperature sensor that provides a small input signal that must be amplified such as by a transistor, a fixed-bias is provided to the base of the transistor rather than using self-biasing to form sharp, clean, pulses that are free from parasitic oscillation, 60 cycle hum, and the like.

Further, the present improved circuit also includes a switch having a plurality of positions (three preferred) that enables, for example only, low, medium or high temperatures, rotating speeds, and light brightness to occur. In one embodiment, the switch is selectively coupled to one of a plurality of resistors, each having a different resistance value, coupled to the collector of an amplifying transistor to change the value of the input control signal level to the comparator and thus change the output level of the comparator that drives the FET switch.

Thus, one of a particular temperature setting can be selected for a heat generating device. Also, one of different rotating speeds can be selected for a rotating device and one of different values of lighting intensity can be selected for a light source.

In another embodiment, these resistors can be paralleled by a sliding switch to provide a plurality of different parallel resistor combinations, and thus resistance values, and thereby establish a plurality of different operating conditions such as temperatures, rotating speeds, and light brightness, for examples only.

In addition, the novel circuit may also be provided with at least one other alternate modification to allow a device to provide low, medium, and high operating conditions such as temperatures as was described above. In the temperature instance, the power switch, or FET, is by-passed by one of a plurality of bi-metal temperature switches, connected to a manually controlled switch so that the load is connected directly to ground potential through the selected one of the bi-metal temperature switches. These bimetal switches can be set to open at any desired temperature. For instance, one of them may open at a temperature of 140° F. A second one of them may be set to open at a temperature of 170° F. A third one of them may be set to open at a temperature of 200° F. Thus, which ever one of the bi-metal temperature switches is selected with the manually controlled switch, until the load reaches the desired temperature, the FET switch, although being driven by the control circuit, is by-passed by the selected closed bi-metal switch and the desired temperature is reached in a minimum of time. When the load reaches the desired temperature, the bi-metal switch opens and the FET, being driven by the control circuit, is effective and begins to regulate the load at that temperature.

The novel circuit also includes as an alternative, a fast-heat switch that can be manually depressed, or actuated, by the device operator and, when actuated, creates a circuit that again by-passes the FET and connects the load directly to ground potential to cause rapid heating of the load. When the temperature is sufficiently hot, as determined by the operator, the switch is released and the control circuit again controls the temperature.

Also, the novel circuit, when controlling a light source, may use a feedback signal proportional to the heat of the light bulb filament or the light brightness as determined by any well-known light sensor, such as a cadmium-sulfide cell or a photo-detector, and thus provide power sufficient only to compensate for load losses such as filament cooling, and the like.

When controlling a rotating device that has momentum (stored energy or residual power), the rotational speed of the device, as detected by an rpm indicator, for example only, can be used to generate a signal representative of the rotational speed and that signal can be used as the feed back signal, as described above, to drive the rotating device at a desired speed by supplying pulse time modulated signals to an electronic switch to apply power to the load sufficient only to compensate for load losses such as friction, system losses, and the like.

In one embodiment, a well-known pulse width modulator circuit for driving a motor is modified to accept a feed back signal so as to automatically drive a rotating device at a desired speed by applying pulse time modulated power to the device, once the desired speed is reached, sufficient only to compensate for system and load losses.

Thus, it is an object of the present invention to obtain a desired output power from an electrical load using Pulse Time Modulated signals to replace only the system and load losses thereby enabling any Residual Power to equal the desired output power and therefore conserve input power.

It is another object of the present invention generate a feedback signal representing the desired operating condition of the load, compare the feedback signal with a variable time based electrical reference signal and generate the Pulse Time Modulated signals based on the comparison.

It is still another object of the invention to provide a control circuit including fixed-bias transistors to amplify the received feedback signal.

It is yet another object of the present invention to provide a plurality of load operating conditions such that any one of the plurality of conditions can be selected by the user of the device.

It is also an object of the present invention to provide an electronic switch that is controlled by the Pulse Time Modulated signals to achieve and maintain a desired load condition.

It is another object of the present invention to provide a user controlled load operation condition by providing a manually operated switch that by-passes the electronic switch when actuated to cause full input power to be applied to the load until a user desired operating condition is achieved.

Thus, the present invention relates to a method of obtaining a desired output power, Pₒ, from an electrical load, where Pₒ=Pᵢₙ−Pₗ+Pᵣ, comprising the steps of: supplying a continuous power input, Pᵢₙ, to the load to achieve the desired output power, Pₒ, and creating a residual, or stored, power, Pᵣ, and automatically using Pulse Time Modulation to reduce the input power, Pᵢₙ, to an amount sufficient only to replace system and load losses, Pₗ, thereby maintaining the desired power output, Pₒ, equal to the residual power, Pᵣ, with reduced input power, Pᵢₙ.

The present invention also relates to apparatus for automatically obtaining a desired output power, Pₒ, from an electrical load of a system with reduced input power, Pᵢₙ, where Pₒ=Pᵢₙ−Pₗ+Pᵣ where Pₗ=Power losses expended in the load as well as any system losses, and Pᵣ=-residual Power stored in the load at the desired output power, comprising a power source for supplying continuous input power, Pᵢₙ, to the load to achieve the desired output power, Pₒ, with an accompanying residual power, Pᵣ and a control circuit coupled between the power source and the load for automatically supplying Pulse Time Modulated signals to reduce the input power, Pᵢₙ, applied to the load to an amount sufficient only to replace the power losses, Pₗ, thereby just maintaining the residual power, Pᵣ, equal to the desired output power, Pₒ, to conserve electrical power and prolong the life of the load.

### BRIEF DESCRIPTION OF THE DRAWINGS

These and other more detailed advantages of the invention will be more fully described in the following detailed description of the drawings wherein like numerals represent like elements and in which:

FIG. 1 is a generalized circuit diagram as disclosed in commonly assigned co-pending provisional patent application, Ser. No. 60/545,783 that is modified by the present invention to improve the operation thereof;

FIG. 2 illustrates one embodiment of a circuit for modifying the circuit of FIG. 1 to select one of a plurality of parallel resistors in the collector of the amplifying transistor with a rotary switch to enable different load operating conditions to occur;

FIG. 3 illustrates a second embodiment of a circuit for modifying the circuit of FIG. 1 to use a sliding switch to select at least one of the plurality of parallel resistors to enable different load operating conditions to occur;

FIG. 4 illustrates a pulse time modulated pulse that is distorted by parasitic oscillations, noise, sixty cycle hum interference, and other offensive interfering signals;

FIG. 5 illustrates at least one circuit for removing the pulse distortion shown in FIG. 4;

FIG. 6 illustrates a circuit for improving the time required for a particular type load of FIG. 1 to reach a desired operating temperature;

FIG. 7 illustrates a circuit for improving the circuit of FIG. 1 by providing a user controlled switch that enables the device of FIG. 1 to apply full power to the load for as long as the operator wishes;

FIG. 8 illustrates the use of the present invention to automatically control the illumination of a light source to a desired illumination;

FIG. 9 illustrates the use of the present invention to automatically control the rotation of a rotating device to a desired rpm;

FIG. 10 illustrates an existing motor control circuit that has been modified with the present invention to control the power applied to a load; and

FIG. 11 illustrates the relationship of the load feedback signal and the varying time based reference signal to generate pulse time modulation.

### DETAILED DESCRIPTION OF THE DRAWINGS

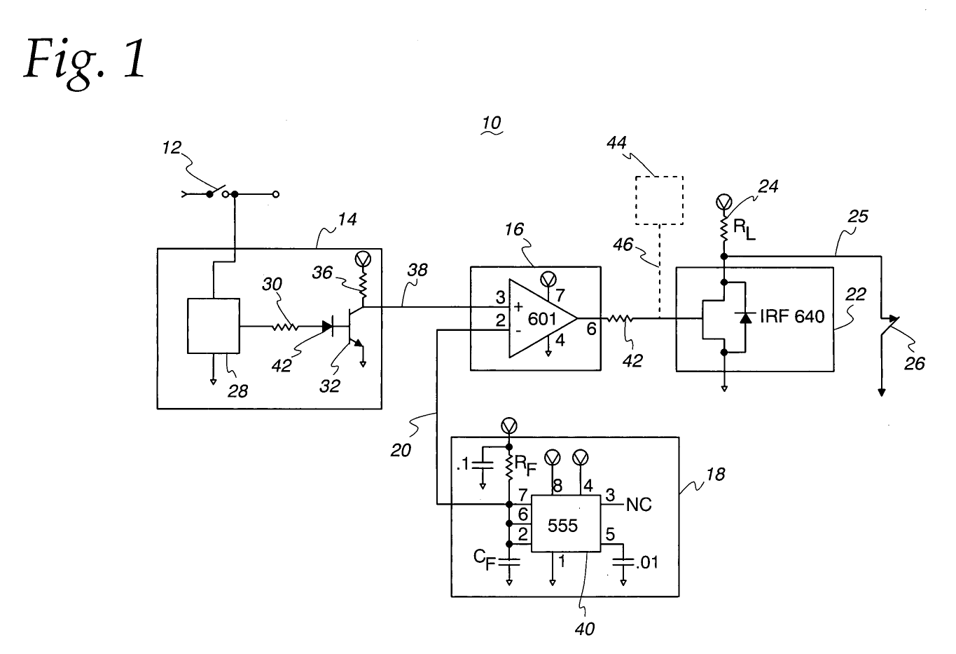

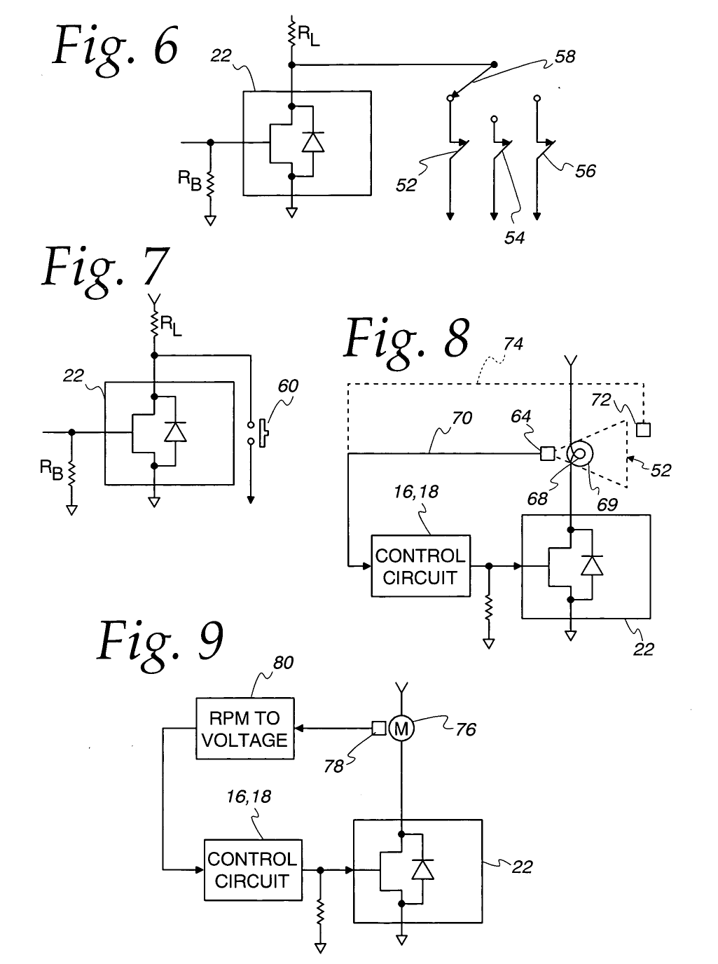

The circuit of FIG. 1 is the basic circuit disclosed in FIG. 6 of commonly assigned co-pending provisional patent application Ser. No. 60/545,783 that is improved with the present invention.

The circuit 10 consists generally of a switch 12 that, when actuated, couples a source of power to each element in the unit. It also has, as major components, the heat sensing unit 14, the comparator unit 16, the time based reference signal generator 18, and the electronic power switch (FET) 22 for providing pulsed power to load 24 to regulate the energy applied thereto.

The heat sensing unit 14, for example only, may comprise an LM 34 thermistor 28 as the heat sensor. It has a power input, a ground connection, and a signal output. The output signal is coupled through resistor 30 and isolation diode 32 to the base of an operational amplifier 34 (for example, a well-known 2222 A transistor). The power source is coupled through collector resistor 36 to transistor 34.

As the sensed heat increases, the conduction of transistor 34 begins to increase and the voltage at the junction of the load resistor 36 and the comparator 16 input pin 3 on line 38 begins to decrease from its maximum value. The value of the output signal from transistor 34 on line 38 is compared by comparator 16 with the value of the varying time based output signal (e.g. a sawtooth waveform) from generator 18 on line 20 to pin 2 of the comparator 16.

The comparator 16 may be formed with any well-known comparator chip such as a 601 or 741 IC chip. The varying time based generator 18 may be formed with, for example only, a 555 IC chip 40 well-known in the art or from a simple RC time constant circuit.

As explained in the above mentioned commonly assigned co-pending provisional patent application, the comparator 16 produces an output signal at pin 6 to resistor 42 ONLY during the period of time in which the heat sensor output signal on line 38 to pin 3 of the comparator 16 is greater in amplitude than ANY portion of the varying time based output signal from generator 18 on line 20 to pin 2 of the comparator 16.

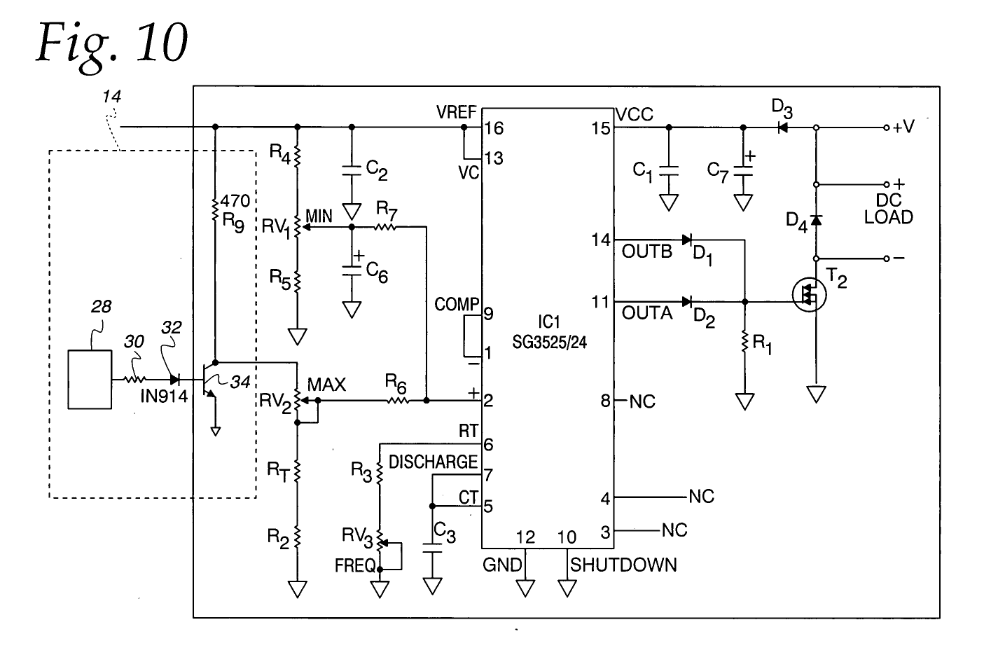

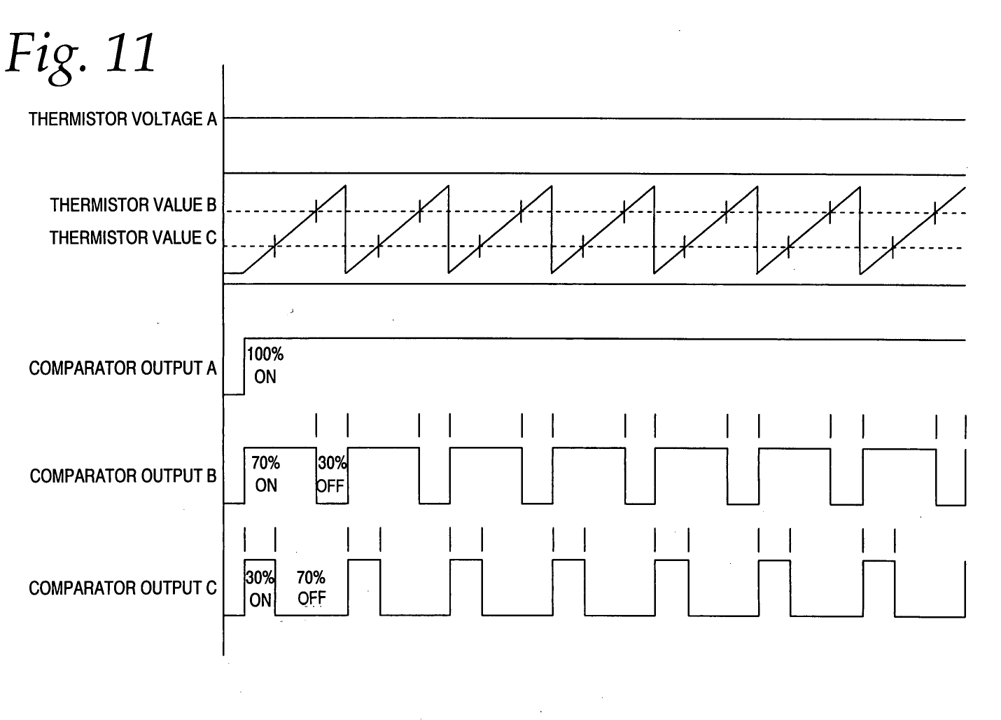

FIG. 11 herein (FIG. 10 in the above mentioned commonly assigned provisional patent application) illustrates this operation. Several different thermistor output signal values, and corresponding values of the varying time based reference signal (in this case, a sawtooth waveform) are illustrated. When the amplitude of the sensor output signal, designated as thermistor voltage A, is greater than the maximum amplitude of the reference signal, the comparator 16 generates a command signal to the electronic switch 22, the power FET, that is continuous as is shown by the comparator output designated waveform A. Thus, continuous power is supplied to the load 24.

However, when the output signal cause by the heat sensor unit 14 is a level B, the comparator 16 generates an output signal ONLY during the time period in which the signal caused by the heat sensor unit 14 is greater than ANY portion of the varying time based generator 18 (here shown as a sawtooth) signal. Thus, comparator 16 output curve B illustrates that the comparator 16 is ON and generating an output signal to the FET switch 22 ONLY about 70% of the time and is OFF about 30% of the time. This means, of course, that only 70% of the maximum power is being supplied to the load 24. The output of the comparator 16 is therefore a Pulse Time Modulated signal.

When the output signal of the comparator 16 is at level C, comparator 16 output waveform designated as C shows that the FET 22 is turned ON only about 30% of the time and the FET 22 is turned OFF about 70% of the time by the Pulse Time Modulated signal.

FIG. 2 illustrates an improvement of the circuit shown in FIG. 1 that enables, for example only, three different load operating conditions to occur such as high, medium, and low temperatures, rotational speeds, and light brightness. This occurs by driving the amplifying transistor 34 with at least two power levels to create at least two of a low, medium, and high control signals to the electronic power switch 22 to cause at least two operating condition levels to occur.

A transistor amplifier, such as transistor 34, operates on one of its characteristic operating curves depending upon the current flow through the transistor. To change such operating curves and allow for different operating points, at least two (and preferably three) resistors R₁, R₂, (and R₃), each having a different resistance value such as 100 Ω, 330 Ω, (and 470 Ω), are connected at one end to the collector of transistor 34. A rotary switch 48 couples the input power to the other end of a selected one of the resistors to change the operating characteristic of the transistor 34 and thus change the value of the output signal applied to pin 3 of the comparator 16. Thus, in this example, at least three different load operating conditions are achieved with the setting of switch 48.

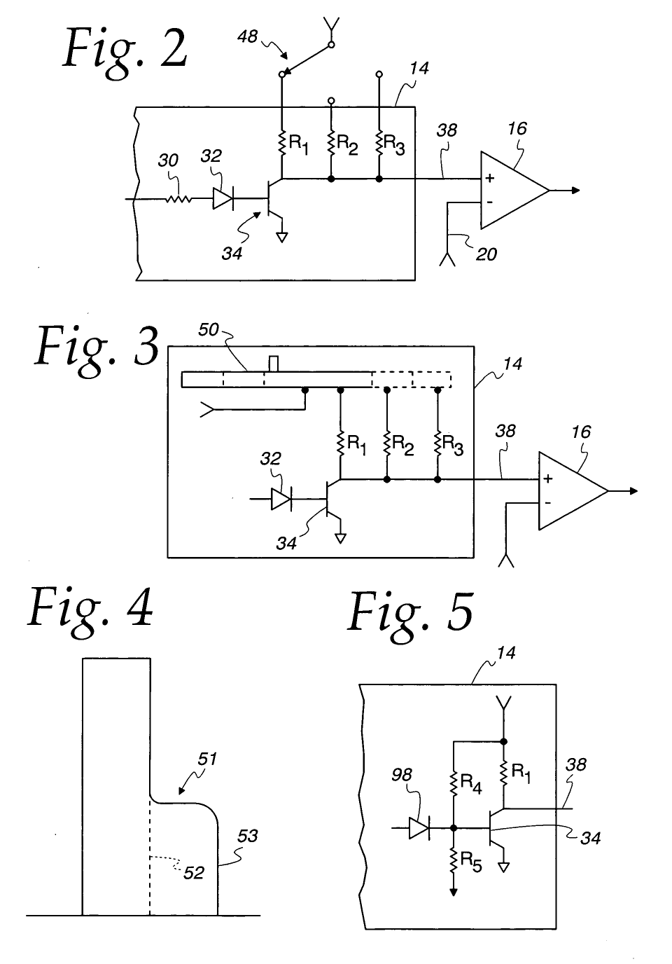

FIG. 3 illustrates a second embodiment for selecting the amount of resistance to be inserted between the power supply and the collector of the transistor 34. In this case, a sliding switch 50 is arranged such that it can select resistor R₁ only, resistors R₁ and R₂ in parallel, or resistors R₁, R₂, and R₃ in parallel thus enabling the selection of any one of three different resistor values to be connected to the collector of the transistor 34 to vary the load operating conditions. The circuit then operates as described previously.

FIG. 4 illustrates one pulse 51 of the pulse time modulated signals that drive the power electronic switch 22 (FET) when the pulse 51 is influenced by parasitic oscillations, 60 cycle energy, electrical noise of any sort, and other additional offensive interfering signals. The FET 22 should be turned completely OFF and ON to operate properly. If the regulating pulses applied to its gate are of the type shown in FIG. 4, the distortion 53 prevents the FET from turning completely OFF and causes the FET to heat and eventually to malfunction.

The circuit shown in FIG. 5 eliminates the distortion of the pulse shown in FIG. 4 and provides a sharp, clean pulse with straight edges as illustrated by the phantom line 52 shown in FIG. 4.

One of the reasons that the distortion appears on the waveform shown in FIG. 4 is that the transistor 34 is self-biased and any distorted signal, or signal interference, appearing at the base of the transistor 34 is amplified. To eliminate this problem, a fixed bias voltage level is applied to the base of transistor 34 by means of a resistor divider network coupled between the power source and ground potential comprising serially connected resistors R₄ and R₅, each having a different resistance value, and the junction of which is connected to the base of transistor 34. Thus, depending upon the resistance value of the resistors R₄ and R₅, a preset signal is applied to the base of transistor 34 that eliminates any interference or distortion, shown in FIG. 4, on the applied pulses to base of the electronic power switch or FET 22.

In order to supply continuous input power, Pᵢₙ, to the load to achieve the desired output power at different power settings (i.e. low, medium, or high temperatures in this case) PRIOR to the power FET controlling the load, the circuit of FIG. 6 is utilized. As can be seen in FIG. 6, the electronic switch 22 is by-passed by a plurality of bi-metal temperature switches placed between the load, Rₗ, and ground potential. In this case, a plurality of bi-metal switches 52, 54, and 56 is provided. Each of the bi-metal switches stays closed until its operating temperature is reached and the selected switch then opens and allows the control circuit to control the power FET 22. A particular bi-metal switch that will open at a desired temperature is selected with a multi-position switch 58 that is coupled between the bi-metal switches and the load, Rₗ. It will be noted in FIG. 6 that a biasing resistor, R_{b}, is connected between the gate of the power FET 22 and ground potential. This biasing resistor, R_{b}, causes the power FET to stabilize and provide consistent operation.

It may desirable for the user of a power controlled device to operate the device at any power condition selected by the user. This is accomplished in FIG. 7 by placing a manually operated switch in parallel with the power FET 22. Thus, the user may simply depress switch 60 and provide full, unregulated, power to the load, Rl, for as long as the user desires. If therefore the device is set to operate at a low power setting, such as a temperature setting, the user simply manually operates switch 60 and holds the switch engaged for as long as desired. The device will then have full, continuous, power applied to the load as long as the switch 69 is actuated.

As stated earlier, this novel improved circuit may be used to control a plurality of different loads. For instance, as shown in FIG. 8, the illumination of a light source as the load may be controlled at a desired illumination. In FIG. 8, a heat sensor, such as a thermistor as described earlier, may be used to sense and measure the heat generated by the light source. The thermistor, 64, detects, for example only, the heat generated by the filament 68, or the shell, casing, or glass 69 of a light bulb. It automatically converts this sensed and measured heat value to an electrical signal that is coupled to control circuit 16, 18 on line 70 and the control circuit operates as explained previously to maintain a selected output illumination.

Also, as shown in FIG. 8, the illumination of the light may be detected by a light detector such as a cadmium-sulfide cell or a photo cell 72. Again, the detected illumination is converted to an electrical signal that is coupled on line 74 back to the control circuit 16, 18 and used to control the power FET 22 as described previously.

FIG. 9 illustrates a circuit for controlling the rotating speed of a device such as a motor 76. Again, a feedback device, such as tachometer 78 detects the rpm of the rotating device 76. The tachometer 78 may, itself, convert the rpm value to a corresponding electrical signal used as a feedback signal to the control circuit 16,18 as an input signal as described earlier. If the tachometer does not directly convert the rpm to an electrical signal, then any well-known converter 80 can be used to convert the rpm signal to an electrical feedback signal. The circuit then operates as previously described to use Pulse Time Modulated signals to automatically reduce the input power, Pin, to an amount sufficient only to replace rotational losses, frictional losses, and system losses, Pₗ, thereby conserving power and prolonging the life of the rotating device. Thus, the motor rotational speed is automatically controlled at a desired rpm.

It is believed that the reasons for obtaining improved efficiencies in motor control with the novel circuit disclosed herein (58% increase in run time with a given battery power being pulsed to the motor as compared with the same battery power applied directly and continuously to the motor) are several. First, with the novel pulsing circuit, there is no constant current drain on the battery. It is well known in the art that a constant power drain on the battery causes a rise in battery temperature. It is also well known that the internal resistance of a battery increases with a rise in battery temperature. When the resistance increases, there is a greater internal power loss within the battery cell and the battery continues to heat and the cycle continues until the battery cannot generate any further power output even though it may have voltage measured at its output terminals.

With the battery being pulsed as it is with the novel pulsing circuit disclosed herein, the battery runs at a cooler temperature because there is no constant drain on the battery. With the cooler temperature, the battery life for a given load cycle is increased and the total battery life span is extended enabling it to be recharged more times.

Thus, the present novel pulsing circuit not only allows the battery temperature to be decreased but, in the process, gives a longer load cycle battery life as well as a longer total battery life.

Also, it is believed that the pulse duty cycle and pulse frequency applied to a given motor, if set properly, may be matching the input impedance of the motor thus obtaining maximum power transfer at that proper setting as is well known in the art.

It is also well known in the art that a DC power source or battery has an AC impedance and a DC motor also has an AC impedance. Battery AC impedance is defined as the ratio of an AC voltage applied across a battery to the resulting current through the battery. With the present novel circuit, it may be that, at the proper operating pulse duty cycle and pulse frequency, the AC impedance of the battery matches the AC impedance of the motor thus again causing a maximum transfer of power at the matched impedance value.

As indicated earlier, circuits do exist to control, for instance, motor rotational speed. However, such circuits do NOT automatically control the motor speed but use a potentiometer to manually vary the speed of the motor. Such a circuit is shown in FIG. 10 with a modification to require the circuit to automatically control any electrical load, including a motor speed at a desired rpm. In the circuit in FIG. 10, the control unit has been modified to automatically control the temperature of a device. It can be seen that temperature sensing unit 14, shown in FIG. 1, has been added to provide the feedback input to the circuit through potentiometer RV2 and resistor R6 to pin 2 of the IC chip. The circuit then works as explained earlier with respect to the circuit of FIG. 1.

The entire circuit shown in FIGS. 1-3 and 5-10 can be placed on a single Application Specific Integrated Circuit (ASIC) chip including the set point resistors shown in FIG. 5.

Thus there has been disclosed an improved circuit for energy conservation that automatically controls a load at a desired operating condition by providing circuits that enable a plurality of load operating conditions to be controlled, that provide substantially interference free pulse time modulation pulses to an electronic power switch (FET) to prolong the life of the FET and provide stable operation of the FET and to obtain fast heating of the load to one of a plurality of temperature settings by placing a plurality of bi-metal switches in parallel with the electronic switch (power FET). Each of the bi-metal switches opens at a different temperature so that by using a multiposition switch, a particular bi-metal switch can be selected to allow full power to be coupled to the load until the predetermined temperature of the selected bi-metal switch is reached and then the circuit uses Pulse Time Modulation signals to automatically control the device at that selected temperature.

Also, there has been disclosed a user operated manually controlled switch that can be actuated by the user to by-pass the FET and provide full power to the load for as long as the user actuates the manually controlled switch.

It is to be understood that the term “electronic switch” as used herein is intended to cover suitable switch that can be controlled to intermittently supply power to a load including mechanically operated switches such as a relay or a solid state switch such as a Field Effect Transistor (FET) as discussed herein previously.

While the preferred embodiments have been shown and described, various modifications and substitutions may be made thereto without departing from the spirit and scope of the invention. Accordingly, it is to be understood that the present invention has been described by way of illustration and not limitation.

The corresponding structures, materials, acts, and equivalents of all means or step plus function elements or method steps in the claims below are intended to include any structure, material, or act for performing the function in combination with other claimed elements as specifically claimed.

1. A method of automatically obtaining a desired output power, Pₒ, from an electrical load of a system with reduced input power, Pᵢₙ, where Pₒ=Pᵢₙ−Pₗ+P_{r,} where P₁=Power losses expended in the load as well as any system losses and Pᵣ=Power that is residual power stored in the load at the desired output power, comprising the steps of:
supplying continuous input power, Pᵢₙ, to the load to achieve the desired output power, Pₒ, with an accompanying residual power, Rᵣ; and
using variable rate pulse time modulated signals to automatically reduce the input power, Pᵢₙ, to an amount sufficient only to replace the power losses, Pₗ, thereby just maintaining the residual power, Pᵣ, equal to the desired power output, Pₒ, thereby conserving input power and prolonging the life of the load.

2. The method of claim 1 wherein the step of automatically reducing the electrical input power, Pᵢₙ, further comprises the steps of:
generating a feedback signal representing instantaneous load output power, Pₒ; and
using the generated feedback signal to cause the pulse time modulation (PTM) of the input power, Pᵢₙ, to reduce the input power, Pᵢₙ, applied to the load to an amount sufficient only to replace power losses, Pₗ, thereby conserving electrical power by maintaining the desired load output power with reduced input power.

3. The method of claim 2 further comprising the steps of:
coupling an electronic power switch between the electrical load and ground potential, the electronic power switch having a source, a drain, and a gate to cause the electronic power switch to turn ON and OFF; and
applying the pulse time modulation signals to the gate of the electronic power switch to turn the power switch ON and OFF with the pulse time modulation signal thereby reducing the input power required to maintain the desired output power.

4. The method of claim 3 wherein the step of generating a feedback signal representing the desired load output power, Pₒ, further comprises the steps of:
detecting the instantaneous output power, Pₒ, of the electrically generated load with a transducer that produces an electronic feedback signal representing the instantaneous output power of the load; and
providing a control circuit for receiving the feedback signal and generating the pulse time modulated output signal that reduces the desired load output power.

5. The method of claim 4 wherein the step of providing a control circuit for receiving the feedback signal and generating the pulse time modulation signal further comprises the steps of:
generating a varying time based reference signal representing a range of load output power; and
coupling the varying time based reference signal and the generated feedback signal representing the desired load output power to the control circuit such that when the generated feedback signal is greater than the maximum value of the varying time based reference signal, continuous power is supplied to the load and when the generated feedback signal is less than any part of the varying time based reference signal, the pulse time modulated signal is supplied to the electronic power switch to control the input power to the load.

6. The method of claim 4 wherein the step of providing a control circuit to receive the feedback signal and generate a signal representing a desired load output power further comprises the steps of:
coupling the received feedback signal to an amplifying transistor having a base, a collector, and an emitter; and
providing a fixed bias voltage to the base of the transistor to create time based modulation pulses that are free from any one of a parasitic oscillation, 60 cycle hum, and any additional offensive interfering signals.

7. The method of claim 6 further comprising the step of:
driving the transistor with one of at least two power levels to create at least one of two different pulse time modulated signals that are coupled to the electronic power switch to cause at least two different load operating conditions to occur.

8. The method of claim 7 wherein the step of driving the transistor further comprises the steps of:
coupling a plurality of different resistors having different resistor values to the collector of the transistor; and
connecting electrical power to a switch having a like plurality of positions to select at least one of the resistors to vary the load operating condition.

9. The method of claim 8 wherein the step of connecting electrical power to a switch further comprises the step of using a rotary switch to select at least one of the plurality of different resistors to vary the transistor operating conditions.

10. The method of claim 8 wherein the step of connecting electrical power to a switch further comprises the step of using a sliding switch to select a least one of the plurality of different resistors to vary the load operating conditions.

11. The method of claim 4 wherein the step of supplying continuous input power, Pᵢₙ, to the load to achieve the desired output power, Pₒ, further comprises the steps of:
by-passing the electronic power switch by coupling a plurality of bi-metal temperature switches between the load and ground potential, each of the bi-metal switches being set to open at a different temperature; and
selecting the bi-metal switch representing the desired operating temperature such that when the desired operating temperature is reached, the selected bi-metal switch opens and the control circuit is allowed to control the desired load output power with the pulse time modulated signals.

12. The method of claim 11 further comprising the step of coupling a multiposition switch between the load and the plurality of bi-metal switches to select a desired operating temperature by selecting a particular bi-metal switch.

13. The method of claim 3 further including the step of reaching a desired operating condition in a minimum of time.

14. The method of claim 13 wherein the step of reaching a desired operating condition in a minimum of time further comprises the steps of:
coupling a manually operated switch between the load and ground potential; and
bypassing the electronic power switch when the manually operated switch is actuated to provide full, continuous power to the load until the manually operated switch is deactuated.

15. The method of claim 1 further comprising the step of:
controlling a light source, as the load, at a desired illumination.

16. The method of claim 15 further comprising the steps of:
measuring the value of either one of heat generated by the light source and intensity of the illumination of the light source;
converting the measured value to an electrical signal; and
using the electrical signal to form a pulse time modulated signal to automatically reduce the input power, Pᵢₙ, to an amount sufficient only to replace heat losses of the heat source and any system losses, Pₗ, thereby conserving power and prolonging the life of the light source.

17. The method of claim 16 wherein the step of converting the value of the heat generated by the heat source to an electrical signal further comprises the step using a heat sensing element proximate the source of heat generated by the light source that converts the heat to the electrical signal.

18. The method of claim 16 wherein the step of converting the value of the intensity of the illumination of the light source to an electrical signal further comprises the step of providing a light sensor proximate the beam of light generated by the light source to generate the electrical signal representing the illumination of the light source.

19. The method of claim 18 wherein the step of providing a light sensor further comprises the step of placing one of a cadmium sulfide cell and a photo-detector proximate the beam of light generated by the light source to convert illumination to an electrical signal used as the feedback signal.

20. The method of claim 1 further comprising the step of controlling a rotating device as the load at a desired rotational speed representing the desired output power.

21. The method of claim 20 further comprising the steps of:
detecting the rotational speed of the rotating device,
converting the detected rotational speed to an electrical signal; and
using the electrical signal as the feedback signal to generate pulse time modulated signals that automatically reduce the input power, Pᵢₙ, to an amount sufficient only to replace power losses, Pₗ, thereby conserving power and prolonging the life of the rotating device.

22. Apparatus for automatically obtaining a desired output power, Pₒ, from an electrical load of a system with reduced input power, Pᵢₙ, where Pₒ=Pᵢₙ−Pₗ+Pᵣ, where Pₗ=Power losses expended in the load as well as any system losses, and Pᵣ=Power that is residual power stored in the load at the desired output power, comprising:
a power source for supplying continuous input power, Pᵢₙ, to the load to achieve the desired output power, Pₒ, with an accompanying residual power, Pᵣ; and
a control circuit coupled between the power source and the load for generating pulse time modulated signals that automatically reduce the input power, Pᵢₙ, applied to the load to an amount sufficient only to replace the power losses, Pₗ, thereby just maintaining the residual power, Pᵣ, to equal the desired output power, Pₒ, to conserve electrical power and prolong the life of the load.

23. The apparatus of claim 22 wherein the control circuit for automatically reducing the electrical input power, Pᵢₙ, further comprises:
a sensing device for generating a feedback signal representing the instantaneous load output power, Pₒ; and
the control circuit receiving the generated feedback signal and causing the pulse time modulation (PTM) of the input power, Pᵢₙ, to reduce the input power, Pᵢₙ, applied to the load, to an amount sufficient only to replace load losses, Pₗ, thereby conserving electrical power by maintaining the desired load output with reduced input power.

24. The apparatus of claim 23 further comprising:
an electronic power switch coupled between the electrical load and ground potential, the electronic power switch having a drain coupled to the load, a source coupled to ground potential, and a gate for receiving the pulse time modulated signals to cause the electronic power switch to turn ON and OFF.

25. The apparatus of claim 23 further comprising a relay as the electronic power switch.

26. The apparatus of claim 24 wherein the sensing device further comprises:
a transducer for detecting the instantaneous output power, Po, and producing the generated feedback signal.

27. The apparatus of claim 26 wherein the control circuit comprises:
circuit means for generating a varying time based reference signal representing a range of load output power; and
the control circuit having inputs from the varying time based reference signal generator and the generated feedback signal representing the desired load output power such that when the generated feedback signal is greater than the maximum value of the varying time based reference signal, continuous power is supplied to the load and when the generated feedback signal is less than any part of the varying time base reference signal, the pulse time modulated signal is supplied to the electronic power switch to control the input power to the load.

28. The apparatus of claim 26 further comprising:
an amplifying transistor having a base, a collector, and an emitter;
the transistor base receiving the generated feedback signal; and
a circuit for providing a fixed bias voltage that is coupled to the base of the transistor to cause the creation of time based modulation pulses that are free from any one of a parasitic oscillation, 60 cycle hum, and other additional offensive interfering signals.

29. The apparatus of claim 28 further comprising:
a plurality of resistors, each having a different resistor value, coupled to the collector of the transistor; and
a switch having a like plurality of positions for coupling power to a selected one of the plurality of resistors to thereby cause the transistor operation to vary the load operating conditions.

30. The apparatus of claim 25 further comprising:
at least one bi-metal switch by-passing the electronic switch between the load and ground potential and representing the desired operating temperature; and
a switch for selecting the at least one bi-metal temperature switch representing the desired operating temperature such that when the desired operating temperature is reached, the selected bi-metal switch opens and the control circuit regulates the desired load output power with the pulse time modulated signals.

31. The apparatus of claim 30 further comprising:
a plurality of the bi-metal temperature switches, each of the bi-metal switches being set to open at a different temperature
a multiposition switch coupled between the load and the plurality of bi-metal switches to select a desired operating temperature by selecting a particular bi-metal switch.

32. The apparatus of claim 25 further comprising:
a fast operating circuit coupled in parallel with the electronic switch to enable the desired operating condition to be reached in a minimum of time.

33. The apparatus of claim 32 further comprising:
a manually operated switch coupled between the load and ground potential; and
the manually operated switch, when actuated, by-passing the electronic switch to provide full, continuous power to the load until the manually operated switch is deactuated.

34. The apparatus of claim 23 wherein the load is an electrical light source to be controlled at a desired illumination.

35. The apparatus of claim 34 further comprising:
a device for generating an electronic feedback signal representing the illumination of the light source; and
the control circuit receiving the electronic feedback signal and automatically reducing the input power, Pᵢₙ, to the light source by an amount sufficient only to replace power losses, Pₗ, of the light source thereby conserving battery power and prolonging the life of the light source.

36. The apparatus of claim 35 wherein the device for generating an electronic feedback signal representing the illumination of the light source is a heat sensing element proximate the light source that converts heat to an electrical signal proportional to the light illumination.

37. The apparatus of claim 35 wherein the device for generating an electronic feedback signal representing the illumination of the light source is a light sensor proximate the beam of light generated by the light source to generate the electrical signal representing the illumination of the light source.

38. The apparatus of claim 37 wherein the light sensor is one of a cadmium-sulfide cell and a photo-detector.

39. The apparatus of claim 22 wherein the load is a rotating device to be controlled at a desired rotational speed representing the desired output power.

40. The apparatus of claim 39 further comprising:
a rotational speed detector for detecting the rpm of the rotating device and converting the rotational speed to an electrical feedback signal; and
the control circuit receiving the electrical feedback signal to generate pulse time modulated signals that automatically reduce the input power, Pᵢₙ, to an amount sufficient only to replace power losses, Pₗ, thereby conserving power and prolonging the life of the rotating device.
